(19) United States
(12) Patent Application Publication
(10) Pub. No.: US 2010/0273271 A1
(43) Pub. Date: Oct. 28, 2010

(54) SOLUTION MEASUREMENT METHOD AND SOLUTION MEASUREMENT APPARATUS

(75) Inventors: Takahiko Tanida, Ehime (JP); Koji Miyoshi, Ehime (JP); Masahiro Aga, Ehime (JP); Ryosuke Yamada, Ehime (JP); Hideyuki Kurokawa, Ehime (JP); Yoko Matsuda, Ehime (JP); Mie Takahashi, Ehime (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATON, Osaka (JP)

(21) Appl. No.: 12/810,391

(22) PCT Filed: Dec. 4, 2008
(86) PCT No.: PCT/JP2008/003586

§ 371 Date: Jun. 24, 2010

(30) Foreign Application Priority Data
Dec. 27, 2007 (JP) 2007-335425

(51) Int. Cl. G01N 21/00; G06K 9/00

(52) U.S. Cl. 436/164; 382/134

(57) ABSTRACT

A solution measurement method in which a specimen X stored in a capillary 8 is developed from the capillary 8 to the development layer of a test piece, and the amount of a substance to be measured in the specimen X is calculated by measuring the optical property of a predetermined portion to be measured, the method including: measuring the portion to be measured, in response to a reduction of the specimen X in the capillary 8 to a predetermined amount or less; and calculating the amount of the substance to be measured in the specimen X, based on the measured value. According to this method, it, is possible to detect that a certain amount of the specimen X has flown from the capillary 8 to the portion to be measured on the development layer.

### TECHNICAL FIELD

The present invention relates to a solution measurement method and a solution measurement apparatus in which a specimen as a solution to be tested is added to a test piece and is developed thereon and an optical property at a measured portion of the test piece is measured to calculate an amount of substance to be measured in the solution to be tested.

### BACKGROUND ART

As an apparatus for measuring a substance to be measured in a specimen (also called a solution to be tested) such as blood and plasma, a solution measurement apparatus has been already known in which a specimen such as blood and plasma is added to a test piece, the specimen is developed on the test piece, a substance to be measured is read by using the optical property after being immobilized at a predetermined point, and the concentration (amount) of the substance to be measured is measured.

Prior to the explanation of the solution measurement apparatus, first, the test piece used in the solution measurement apparatus will be described below in accordance with the exploded perspective view of the test piece in FIG. 14 and the assembly perspective view of the test piece in FIG. 15. As shown in FIG. 14, a test piece 10 is configured by bonding a porous substrate 2 that serves as a development layer for developing the specimen and a space forming portion 6 that forms a space (solution storage portion) for temporarily storing the specimen, to a PET sheet 1 serving as the base of the test piece 10. On the porous substrate 2, a labeling portion 3 is provided which is coated with a labeling substance to be specifically bound to the substance to be measured in the specimen, and an immobilizing portion 4 serves as a portion to be measured on which an antibody to be specifically bound to the substance to be measured is immobilized. Further, a PET film 5 is bonded to prevent drying of the specimen being developed.

As shown in FIG. 15, the porous substrate 2 is bonded to the PET sheet 1 to increase the strength. Further, a part of the space forming portion 6 is bonded to the PET film 5 of the porous substrate 2 or the PET sheet 1. The space forming portion 6 is made of a transparent material such as a PET sheet and has a recessed shape in cross section. Moreover, the space forming portion 6 has a capillary 8 that serves as a solution storage portion for temporarily storing the dropped specimen and an air hole 7 that is formed on a part of the space forming portion 6. By dropping (adding) the specimen to the capillary 8, the capillary 8 is filled with the specimen to the edge of the air hole 7. The substance to be measured in the specimen is labeled in the labeling portion 3 and is developed by capillarity in the porous substrate 2 along with the specimen. When reaching the immobilizing portion 4, the substance to be measured is immobilized and the remainder of the specimen further develops downstream. The labeling substance immobilized in the immobilizing portion 4 with the substance to be measured is composed of a substance having a light absorbing or emitting property. The optical property of the immobilizing portion 4 is measured and is converted to a concentration by using a calibration curve, so that the concentration of the substance to be measured is determined.

Referring to FIG. 16, the solution measurement apparatus of the prior art will be described below. A solution measurement apparatus 109 is roughly classified into an optical section and a scanning section. The scanning section is made up of an attachment 110 for setting the test piece 10, a stage 112 in which the attachment 110 is set, a detection switch 115 for detecting the insertion of the attachment 110, a feed screw 114 for scanning the stage 112, and a motor 113 for rotating the feed screw 114. The optical section is made up of a laser diode 116, a condenser lens 117, an opening 118, a beam splitter 119, a front monitor 120, a cylindrical lens 121, and a signal monitor 122. Light emitted from the laser diode 116 is condensed by the condenser lens 117 and is shaped into a beam having a predetermined diameter through the opening 118. The shaped beam is split by the beam splitter 119. One of the split beams directly enters the cylindrical lens 121, is shaped into an oval, and then is emitted to the test piece 10. The other beam is incident on the front monitor 120 made up of a light receiving device such as a photo diode and the front monitor 120 outputs a current according to the intensity of light. The output current of the front monitor 120 is used for adjusting the light quantity of the laser diode 116. The output current is converted to a voltage by an I-V (current-voltage) converter 131 and then is inputted to an error AMP 132. The error AMP 132 receives an output command value 133 as an adjusted value of the laser diode 116 and amplifies a difference between the output command value 133 and the output of the front monitor 120 to obtain a current control value. A current controller 137 passes a current to the laser diode 116 according to an output from the error AMP 132 to keep constant an optical output. In FIG. 16, reference numeral 130 denotes a motor controller for controlling the motor 113, reference numeral 122 denotes the signal monitor for detecting reflected light from the test piece 10, and reference numeral 138 denotes an I-V (current-voltage) converter for converting a current from the signal monitor 122 to a voltage value.

Such a solution measurement apparatus is disclosed in Japanese Patent Laid-Open No. 2003-4743 and so on. The following will describe the operations of the solution measurement apparatus. The specimen is dropped to the test piece 10 set on the attachment 110. After the specimen is dropped, the attachment 110 is immediately set in the stage 112, so that the detection switch 115 detects the insertion of the attachment 110 and a detection signal is inputted to the motor controller 130. In response to the detection signal, the motor controller 130 transmits a driving signal to the motor 113 to rotate the feed screw 114 and the stage 112 is scanned. The feed per revolution of the stage 112 is determined beforehand and the stage 112 is scanned up to a position where the outgoing light of the laser diode 116 reaches any position of the test piece 10. At the completion of the movement of the stage 112, the laser diode 116 is driven to emit light to the test piece 10 and the reflected light is received by the signal monitor 122. FIG. 17 is a time-series graph showing the output of the signal monitor 122 at this point. As shown in FIG. 17, when the specimen has not reached a laser irradiation position on the test piece 10, reflected light from the test piece 10 is directly used as a signal monitor output. When the specimen reaches the laser irradiation position containing the immobilizing portion 4, the output of the signal monitor 122 is reduced by the absorption of light on the specimen. By detecting a reduction of the monitor output signal thus, the arrival of the specimen at the laser irradiation position is detected. In the solution measurement apparatus, the light of the laser diode 116 is emitted up to an end of the porous substrate 2.

After it is detected that the specimen has reached the position, the specimen is sufficiently developed for a predetermined standby time, and then measurement is started on the portion to be measured. The motor 113 is driven by the motor controller 130 and the outgoing light of the laser diode 116 is scanned on the test piece 10. A value obtained by performing. LOG conversion on the output of the front monitor 120 by a LOG converter 134 and a value obtained by performing LOG conversion on the output of the signal monitor 122 by a LOG converter 135 are calculated by an arithmetic unit 136, so that an absorbance signal of the test piece 10 is obtained. At the completion of scanning of the test piece 10, the stage 112 is moved to a position where the attachment 110 can be removed, and then the measuring operation is completed.

In this case, when the amount of the dropped specimen is insufficient or in the event of an abnormal flow causing the specimen to clog in the test piece 10, the specimen does not flow to the end of the porous substrate 2, so that the specimen does not reach the light irradiation position of the laser diode 116. In this case, it is decided after a predetermined time that the specimen has abnormally flowed. A user is notified of the abnormal state and the measuring operation is forcibly terminated.

### DISCLOSURE OF THE INVENTION

### Problems to be Solved by the Invention

In the configuration of the solution measurement apparatus of the prior art, however, when there is a time lag between the dropping of the specimen to the test piece 10 and the setting of the test piece 10 in the solution measurement apparatus, the specimen has passed the laser irradiation position upon detection and thus the flow of the specimen cannot be detected.

Further, since the viscosities of specimens are not uniform, the flow rates vary with the viscosities of the specimens during any time period after the specimens are detected at the laser irradiation position. In other words, a specimen having a low viscosity is quickly developed, whereas a specimen having a high viscosity is slowly developed. This factor varies the amounts of the specimens flowing through the immobilizing portion 4 of the test piece 10, and thus measurements started based on development states at the front position of the developed portion of a solution cause different measurement results and reduce measurement accuracy.

The present invention has been devised to solve the problems of the prior art. An object of the present invention is to provide a solution measurement method and a solution measurement apparatus which can satisfactorily detect the flow of a solution to be tested as a specimen and can accurately calculate the amount of a substance to be measured in a state in which a uniform amount of the solution to be tested is developed.

### Means for Solving the Problems

In order to solve the problems of the prior art, a solution measurement method of the present invention in which a solution to be tested is temporarily stored in the solution storage portion of a test piece when added to the test piece, the solution to be tested is developed on the development layer of the test piece from the solution storage portion, the development layer having a portion to be measured, and the amount of a substance to be measured in the solution to be tested is calculated by measuring the optical property of the portion to be measured, the method including: measuring the portion to be measured, in response to a reduction of the solution to be tested to a predetermined amount or less in the solution storage portion; and calculating the amount of the substance to be measured in the solution to be tested, based on the measured value.

According to this method, it is possible to detect that a certain amount of the solution to be tested has flown from the solution storage portion to the portion to be measured on the development layer, and accurately calculate the amount of the substance to be measured in a state in which substantially a uniform amount of the solution to be tested is developed.

The solution measurement method of the present invention further includes: measuring a flowing time from the addition of the solution to be tested to the test piece to the reduction of the solution to be tested in the solution storage portion to the predetermined amount or less; waiting a time period corresponding to the flowing time after the solution to be tested in the solution storage portion reduces to the predetermined amount or less; and calculating the amount of the substance to be measured in the solution to be tested, after the time period and based on the measured value of the portion to be measured.

A solution measurement method of the present invention in which a solution to be tested is temporarily stored in the solution storage portion of a test piece when added to the test piece, the solution to be tested is developed on the development layer of the test piece from the solution storage portion, the development layer having a portion to be measured, and the amount of a substance to be measured in the solution to be tested is calculated by measuring the optical property of the portion to be measured, the method including: measuring the initial storage amount of the solution to be tested in the solution storage portion of the test piece, when the solution to be tested is added to the test piece mounted at a predetermined mounting location or when the test piece on which the solution to be tested has been added is mounted at the predetermined mounting location; measuring the storage amount of the solution storage portion also after the solution to be tested is added; measuring the optical property of the portion to be measured, in response to a reduction of the solution to be tested from the initial storage amount by a predetermined amount in the solution storage portion; and calculating, based on the measured value, the amount of the substance to be measured in the solution to be tested.

According to this method, it is possible to detect that a predetermined amount of the solution to be tested has flown from the solution storage portion to the portion to be measured on the development layer, and accurately calculate the amount of the substance to be measured in a state in which a uniform amount of the solution to be tested is developed.

The solution measurement method of the present invention further includes: measuring a flowing time from the addition of the solution to be tested to the test piece to the reduction of the solution to be tested in the solution storage portion by the predetermined amount; waiting a time period corresponding to the flowing time after the reduction of the solution to be tested in the solution storage portion by the predetermined amount; and calculating the amount of the substance to be measured in the solution to be tested, after the time period and based on the measured value of the portion to be measured.

The solution measurement method of the present invention further includes: measuring the initial storage amount of the solution to be tested in the solution storage portion of the test piece, when the solution to be tested is added to the test piece mounted at a predetermined mounting location or when the test piece on which the solution to be tested has been added is mounted at the predetermined mounting location; and performing at least one of a measurement terminating operation and a warning operation when the initial storage amount of the solution to be tested is smaller than predetermined initial storage setting.

Thus when the solution to be tested is added to the test piece mounted in a solution measurement apparatus or when the test piece on which the solution to be tested has been added is mounted in the solution measurement apparatus, it is possible to prevent measurement in an abnormal state with an insufficient initial storage amount, thereby preventing erroneous measurement of the amount of the substance to be measured.

Further, according to the solution measurement method of the present invention, the test piece is a test piece for chromatography.

A solution measurement apparatus of the present invention in which a solution to be tested is temporarily stored in the solution storage portion of a test piece when added to the test piece, the solution to be tested is developed on the development layer of the test piece from the solution storage portion, and the amount of a substance to be measured in the solution to be tested is calculated by measuring the optical property of a predetermined portion to be measured on the development layer of the test piece, the solution measurement apparatus including: an imaging device for imaging the portion to be measured and the solution storage portion of the test piece; a solution amount detector for detecting, based on imaging information, the amount of the solution to be tested in the solution storage portion; and a controller for measuring the portion to be measured, in response to a reduction of the solution to be tested to a predetermined amount or less in the solution storage portion or a reduction of the solution to be tested by the predetermined amount or more in the solution storage portion, and calculating, based on the measured value, the amount of the substance to be measured in the solution to be tested.

With this configuration, it is possible to detect that a certain amount or a predetermined amount of the solution to be tested has flown from the solution storage portion to the portion to be measured on the development layer, and accurately calculate the amount of the substance to be measured in a state in which substantially a uniform amount of the solution to be tested is developed.

The solution measurement apparatus of the present invention further includes an illuminator for illuminating the test piece with measurement light; and a light receiver for receiving the reflected light of the measurement light having illuminated the test piece.

According to the solution measurement apparatus of the present invention, the illuminator is one of an LED, an LD, and a lamp.

According to the solution measurement apparatus of the present invention, the light receiver is an image sensor.

According to the solution measurement apparatus of the present invention, the test piece is a test piece for chromatography.

### Advantage of the Invention

According to a solution measurement method and a solution measurement apparatus of the present invention, it is possible to measure a substance to be measured in a portion to be measured, in a state in which a uniform amount or substantially a uniform amount of a solution to be tested flows from a solution storage portion, thereby improving measurement accuracy for measuring the solution.

### BRIEF DESCRIPTION OF THE DRAWINGS

FIG. 1 schematically shows a solution measurement apparatus according to an embodiment of the present invention;

FIG. 2 is a flowchart showing a solution measurement method according to a first embodiment of the present invention;

FIG. 3 shows an image obtained by an image sensor before dropping according to the first embodiment of the present invention;

FIG. 4 shows a capillary image obtained by the image sensor before dropping, and an image sensor output according to the first embodiment of the present invention;

FIG. 5A shows a capillary image obtained immediately after dropping according to the first embodiment of the present invention;

FIG. 5B shows a capillary image obtained after a predetermined time since dropping according to the first embodiment of the present invention;

FIG. 6 shows an amount of a specimen in a capillary relative to an elapsed time after the dropping of the specimen according to the first embodiment of the present invention;

FIG. 7 shows a capillary image obtained by the image sensor when the specimen is dropped, and an image sensor output according to the first embodiment of the present invention;

FIG. 8 shows a flowing state of a specimen on a test piece according to a second embodiment of the present invention;

FIG. 9 shows an optical property measuring process according to the second embodiment of the present invention;

FIG. 10 shows an image sensor output at a monitor point according to the second embodiment of the present invention;

FIG. 11 shows a drop detecting process according to a third embodiment of the present invention;

FIG. 12 shows a specimen amount detecting process according to a fourth embodiment of the present invention;

FIG. 13 shows a flow rate of a specimen relative to an elapsed time after dropping according to the fourth embodiment of the present invention;

FIG. 14 is an exploded perspective view showing a test piece of a solution measurement apparatus according to the prior art;

FIG. 15 is an assembly perspective view showing the test piece of the solution measurement apparatus according to the prior art;

FIG. 16 is a schematic diagram showing the solution measurement apparatus according to the prior art; and

FIG. 17 shows a signal monitor output of the solution measurement apparatus according to the prior art.

### BEST MODE FOR CARRYING OUT THE INVENTION

A solution measurement apparatus and a solution measurement method according to embodiments of the present invention will be specifically described below along with the accompanying drawings. A test piece used in the solution measurement apparatus and the solution measurement method according to the embodiments of the present invention is configured as in the solution measurement apparatus of the prior art. Constituent elements having the same functions will be indicated by the same reference numerals.

### First Embodiment

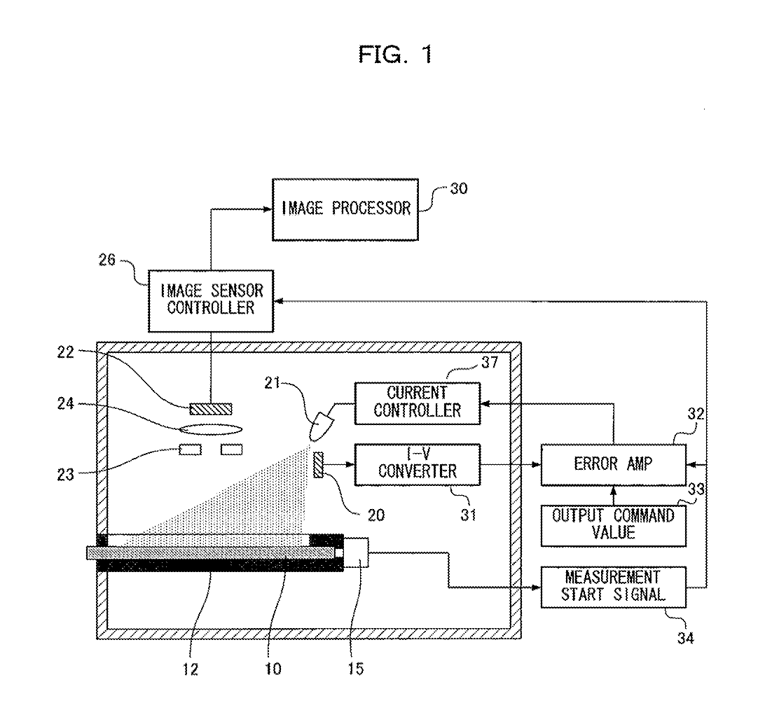

FIG. 1 schematically, shows a solution measurement apparatus according to an embodiment of the present invention. First, the configuration of the solution measurement apparatus will be described below. The solution measurement apparatus includes a stage 12 acting as a test piece holder for positioning and setting a test piece 10 on which a specimen is added (dropped) as a solution to be tested, a detection switch 15 acting as a test piece mounting state detector for detecting the insertion of the test piece 10 into the stage 12, a light source 21 acting as an illuminator made up of an LED (light-emitting diode), an LD (laser diode), or a lamp (for passing current through an electric wire such as a filament to emit light) to illuminate the test piece 10, a front monitor 20 for monitoring the output light of the light source 21, an image sensor 22 that is made up of an image pickup device such as a CCD or a C-MOS and acts as an imaging device for imaging the test piece 10, a diaphragm 23 for adjusting reflected light from the test piece 10, a condenser lens 24 for forming an image of the test piece 10 on the image sensor 22, an image sensor controller 26, an image processor 30, and a controller (not shown).

The following will describe the operations of the light source 21 and the image sensor 22. In this mechanism, an error between the output of the front monitor 20 and an output command value 33 is amplified by an error AMP 32 and is inputted to a current controller 37, and the driving current of the light source 21 is controlled to adjust an amount of light emitted to the test piece 10. The error AMP 32 further receives a measurement start signal 34 synchronized with the detection switch 15 for detecting the insertion of the test piece 10 into the stage 12, and the light source 21 is not turned on unless the test piece 10 is set in the stage 12. The image sensor 22 is driven by the image sensor controller 26 to obtain and transfer data, and the data is outputted as image data to the image processor 30. Further, the image sensor controller 26 does not operate unless the measurement start signal 34 is inputted.

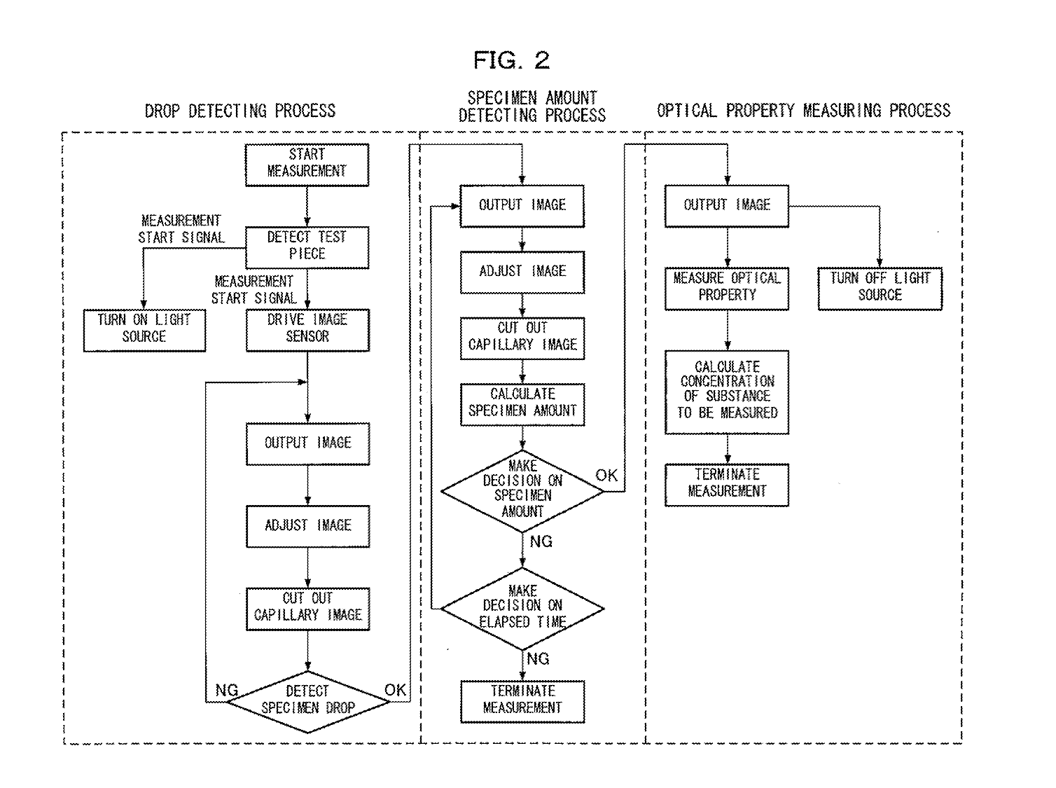

Referring to the flowchart of FIG. 2, the following will describe the measuring operation processes (solution measurement method) of the solution measurement apparatus. A process of measurement is broadly divided into three processes of a drop (an added solution) detecting process, a specimen amount (solution amount) detecting process, and an optical property measuring process. In the drop detecting process, it is detected that a specimen as a solution to be tested has been dropped (added) to the test piece 10, and then a measuring operation is started. In the specimen amount detecting process, an amount of the specimen in a capillary 8 serving as a solution storage portion is measured to determine measurement start timing. In the optical property measuring process, the test piece 10 is imaged on which a predetermined amount of the specimen has flown, and the optical property of an immobilizing portion 4 serving as a portion to be measured is measured and is converted to a concentration (amount) of a substance to be measured in the specimen.

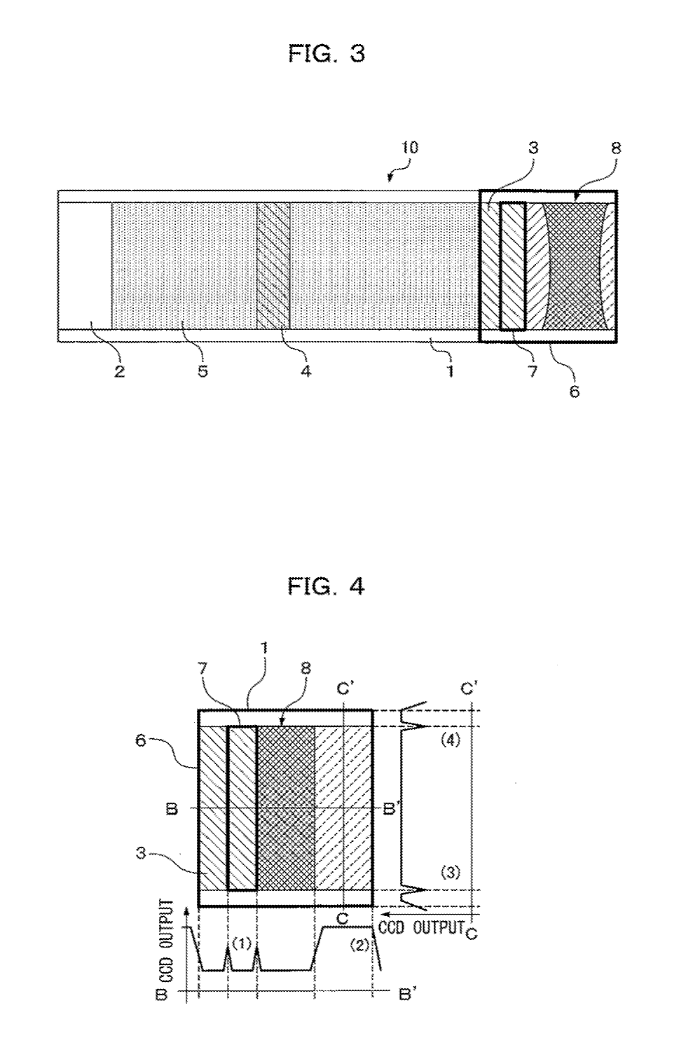

These processes will be sequentially described below. First, the test piece 10 is set in the stage 12 before the specimen is dropped. When the detection switch 15 detects that the test piece 10 has been set, the measurement start signal is outputted from the error AMP 32 to turn on the light source 21 and the image sensor controller 26 is driven to image the test piece 10. This imaging operation obtains an image shown in FIG. 3. By using this image, the dropping of the specimen on the test piece 10 is detected. In order to detect the dropping of the specimen, an image at the point of the capillary 8 is recognized in the image of FIG. 3. A space forming portion 6 forming the space of the capillary 8 is made of a transparent material such as a PET sheet, so that an image of the capillary 8 can be obtained through the space forming portion 6.

The following will describe a method of cutting out the image of the capillary 8. The image is cut out before the specimen is dropped.

In a first method of cutting out the image of the capillary 8, the region of the capillary 8 is specified beforehand as the coordinates of an image of the image sensor. Since the test piece 10 is positioned and mounted by the stage 12, the coordinates on the image sensor image of the capillary 8 can be set so as to be always aligned with the stage 12. Thus the image of the region of the capillary 8 is specified and cut out beforehand according to the coordinates on the image sensor image.

In a second method, an image sensor output is stored and the image of the capillary 8 is obtained from the pattern of an output image. A region for storing the image sensor output is specified beforehand as coordinates on an image sensor image. The region specified at this point is larger than in the first method and can sufficiently contain the capillary 8. FIG. 4 shows an image cut out by the second method. In this case, the region of the space forming portion 6 is cut out as an image. First, an imaging extraction line B-B′ is set substantially at the center of the width direction (also called a shorter direction) of the test piece 10 and in the longitudinal direction (also called a longer direction) of the test piece 10, and an image sensor output is extracted on the imaging extraction line B-B′. In this case, since a labeling substance is applied to a labeling portion 3, light is absorbed and the image sensor output decreases. A porous substrate 2 is made of a white material or a material not absorbing light, so that light is reflected on the porous substrate 2 and the image sensor output increases. The space forming portion 6 is made of a transparent resin and thus hardly affects the image sensor output. An air hole 7 is provided by forming a through hole on the space forming portion 6 and thus light partially reflects on the edge of the air hole 7.

Therefore, the image sensor output on the imaging extraction line B-B′ has characteristics indicated by the lower region of FIG. 4. In FIG. 4, by reading fluctuations in image sensor output between a region (1) having the air hole 7 and a convex region (2) appearing on the end (the right end (dropping side) of FIG. 4) of the test piece 10, the capillary 8 on the test piece 10 is located in the longer direction. Next, in the shorter direction of the test piece 10, an imaging extraction line C-C′ is set so as to contain at least a region where the capillary 8 is provided. An image sensor output on the imaging extraction line C-C′ is indicated in the right region of FIG. 4. The image sensor output on the imaging extraction line C-C′ changes at boundaries (3) and (4) between the capillary 8 and a PET sheet 1. The capillary 8 on the test piece 10 is located in the shorter direction by reading fluctuations in image sensor output at the boundaries (3) and (4). In this way, the capillary 8 on the test piece 10 is located in the longer direction and the shorter direction. During the location of the capillary 8, when it is difficult to determine the points of the regions (1) to (4) shown in FIG. 4, the brightness and contrast of the image sensor output image are adjusted beforehand, so that the region of the capillary 8 can be easily specified.

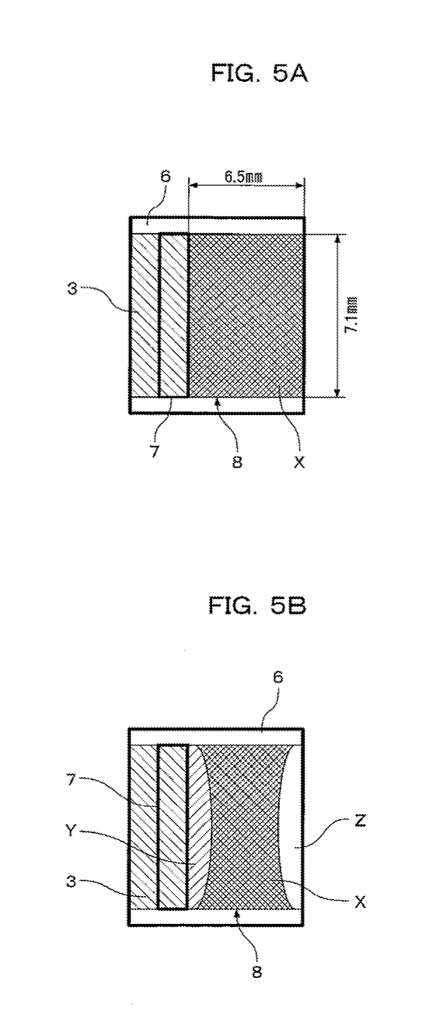

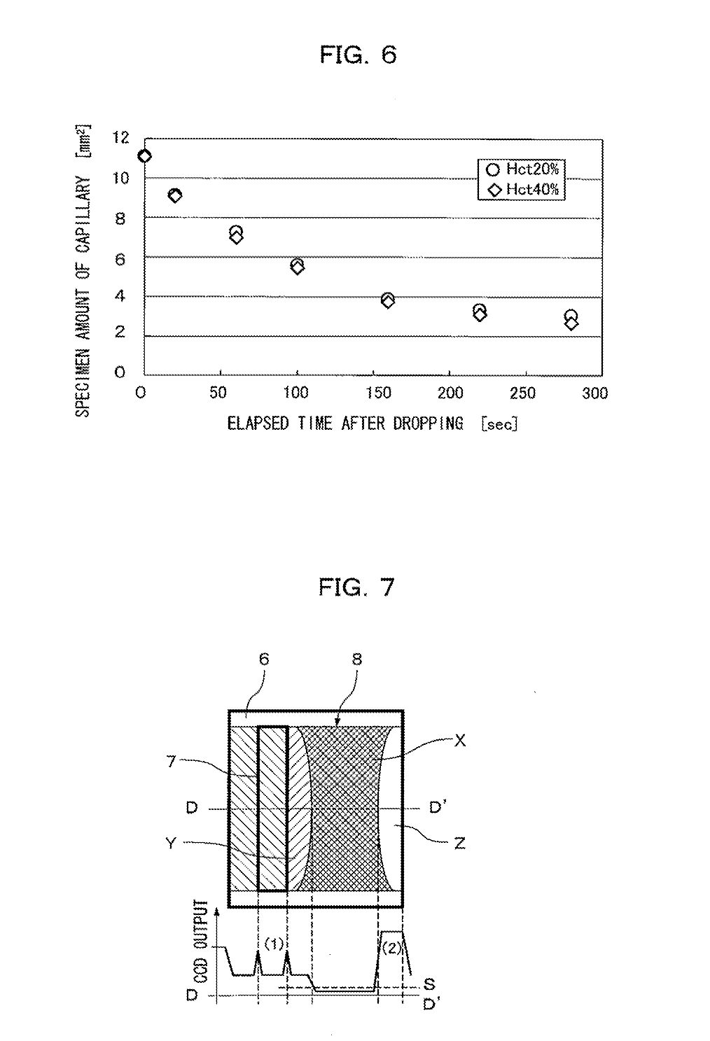

At the completion of the cutting out of the image of the capillary 8, an image sensor output is extracted at a specific point (location) on the image as will be described below. The operations from the cutting out of the image of the capillary 8 to the extraction of the image sensor output at the specific point are repeated until the image sensor output changes. Since the specimen has a light absorbing property, the image sensor output decreases when the specimen is dropped to the capillary 8. A time at which the image sensor output changes is regarded as a specimen dropping time. FIG. 5A is an image of a state of the capillary 8 immediately after the specimen is dropped. At this point, the capillary 8 is filled with a specimen X. FIG. 5B shows a state of the capillary 8 after a predetermined time since the specimen X has been dropped. The dropped specimen X develops on the porous substrate 2 and thus the amount of the specimen X decreases in the capillary 8. At this point, the specimen X decreases and the porous substrate 2 is exposed on the side of the air hole 7. This region is called an air-hole side specimen decreasing region Y and a region where the specimen X decreases on the dropping side is called a dropping-side specimen decreasing region Z. FIG. 6 shows the experimental measured values of the amount of the specimen in the capillary 8 relative to an elapsed time after dropping. In this experiment, used blood specimens have a hematocrit (will be referred to as Hct) of 20% (indicated by circles) and a hematocrit of 40% (indicated by rhombuses) and the amount of the specimen in the capillary 8 is indicated as an area recognized on an image. In this experiment, the porous substrate 2 was nitrocellulose and the capillary 8 had dimensions of, as shown in FIG. 5A, 6.5 mm×1.7 mm (an area of 11.1 mm²) in the longer direction and the shorter direction and a capacity of 5 μl (microliter). As shown in FIG. 6, a reduction in the amount of the specimen tends to decrease with the passage of time because the specimen in the capillary 8 develops on the porous substrate 2. In this experiment, the specimens having a Hct of 20% and a Hct of 40% both reach the end of the porous substrate 2 after a lapse of 160 seconds to 220 seconds since the specimen has been dropped. Thus, for example, when the amount of the specimen in the capillary 8 is 4 mm² or less or the amount of the specimen has a ratio of 0.36 or less relative to the capillary area of 11.1 mm², it is decided that the flow of the specimen has ended.

Referring to FIG. 7, a method of determining the amount of the specimen will be described below. FIG. 7 shows an image of the capillary 8 and a portion around the capillary 8 when the specimen is dropped, and shows an image sensor output. The lower region of FIG. 7 indicates an image sensor output on an imaging extraction line D-D′ crossing the capillary 8 in the longer direction on the test piece 10. Comparing image sensor output values at the points of the air-hole side specimen decreasing region Y, the specimen X, and the dropping-side specimen decreasing region Z, the order of (the output value at the point of the specimen x)<(the output value of the air-hole side specimen decreasing region Y)<(the output value of the dropping-side specimen decreasing region Z) is obtained. Thus binarization is performed using a binarization threshold value S that is the edge of the output value at the point of the specimen X and the output value of the air-hole side specimen decreasing region Y, so that the specimen X can turn black and the air-hole side specimen decreasing region Y and the dropping-side specimen decreasing region Z can turn white. In histogram processing using the binarized image, distribution corresponding to the specimen X (Low) appears around the minimum value of the image sensor output. On the other hand, distribution corresponding to the air-hole side specimen decreasing region Y (High) and the dropping-side specimen decreasing region Z (High) appears at the maximum value of the image sensor output. The numbers of times of occurrence are counted and the amount of the specimen is determined by calculating: the number of counts of Low/(the number of counts of High+Low)×the design area of the capillary 8. As previously mentioned, also in the state of FIG. 7, the capillary 8 can be located by reading fluctuations in image sensor output of the region (1) of the air hole 7 and the end region (2) of the test piece 10.

After the amount of the specimen is determined thus, as shown in FIG. 2, it is decided which process is to be conducted according to the determined amount of the specimen. When the amount of the specimen is 4 mm² or less, the process advances to the optical property measuring process, the test piece 10 is imaged, the optical property of the immobilizing portion 4 is measured by the image processor 30, the optical property information of the immobilizing portion 4 is converted to a concentration (amount) of the substance to be measured, and the measuring operation is completed. In this case, the light source 21 is turned off when the test piece 10 is imaged.

When the amount of the specimen in the capillary 8 is larger than 4 mm² after 300 seconds or more since the dropping of the specimen, it is decided that the specimen is abnormal and the measuring operation is terminated. Within 300 seconds, the test piece 10 is imaged again after several seconds, and then the amount of specimen is measured. This operation is repeated until the amount of the specimen reaches the predetermined criterion or after a lapse of 300 seconds since the dropping of the specimen.

As previously mentioned, in the first embodiment, the amount of the specimen in the capillary 8 is determined after the specimen is dropped to the test piece 10. Based on the determined amount of the specimen, the amount of the specimen developed on the porous substrate 2 is determined. Thus when substantially a uniform amount of the specimen has passed the porous substrate 2 after being dropped to the test piece 10, the substance to be measured can be measured without being affected by the viscosity and the like of the specimen, the substance having been immobilized in the immobilizing portion 4. Therefore, it is possible to reduce variations in measurement accuracy when the variations are caused by varying flow rates of specimens, thereby improving the measurement accuracy of the solution measurement apparatus.

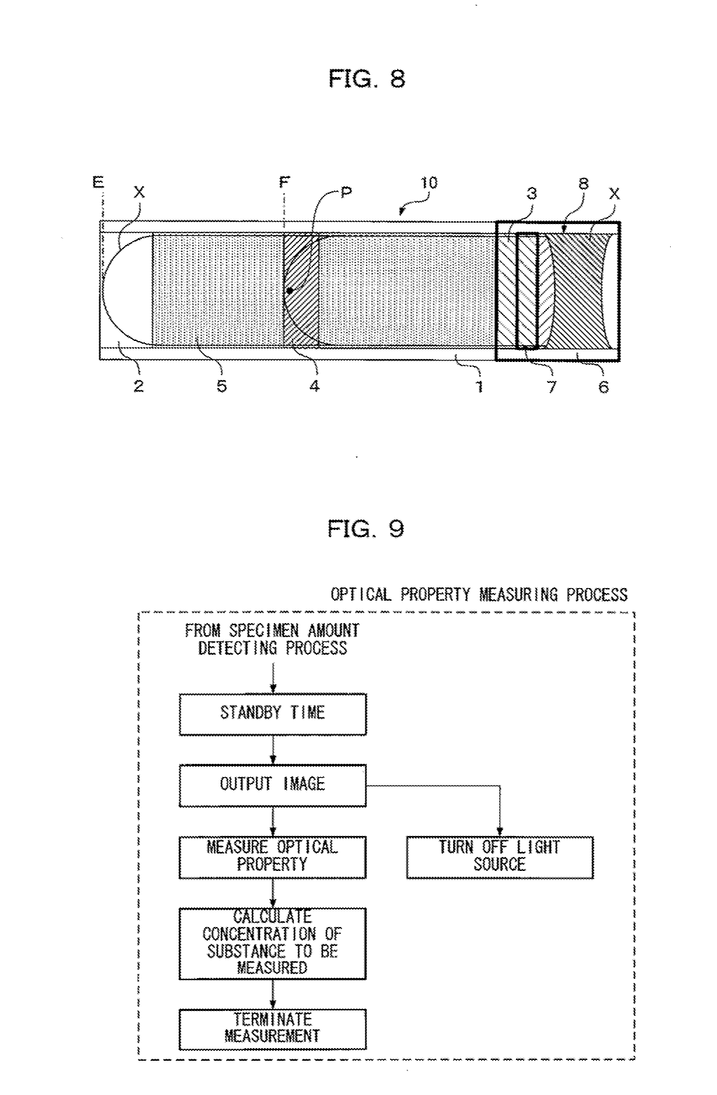

In the present embodiment, the criterion of the amount of the specimen at the start of measurement is set at 4 mm² or less or a ratio of 0.36 or less relative to the capillary area. A different criterion can be set according to the size and kind of the test piece 10 or the capillary 8. As to a criterion of the amount of the specimen at the start of measurement, for example, in FIG. 8 showing a flowing state of the specimen X on the test piece 10, a criterion for starting measurement of an optical property may be a reduction of the typical specimen X flowing to a predetermined position downstream from the immobilizing portion 4 in a developing direction, for example, to an end E of the porous substrate 2. The present embodiment is not limited to this criterion.

Further, in the present embodiment, the amount of the specimen in the capillary 8 is determined by binarization and histogram processing. Any methods may be used as long as an area is determined by image processing.

The present embodiment described the specimens having hematocrits of 20% and 40%. The same criterion is applicable to other specimens having any hematocrits.

### Second Embodiment

A second embodiment will be described below. In the second embodiment, only different points from the first embodiment will be discussed.

In the first embodiment, immediately after the amount of the specimen in the capillary 8 decreases to the predetermined criterion value or less, the process advances to the optical property measuring process to image the test piece 10 and measure the optical property of the immobilizing portion 4 serving as a portion to be measured, whereas in the second embodiment, a criterion for starting measurement of an optical property is a state in which the amount of a specimen in a capillary 8 has decreased to a predetermined criterion value or less and a specimen X appears to have flown to a predetermined position downstream from an immobilizing portion 4 in a developing direction, for example, to an end E of a porous substrate 2. In the state of FIG. 8, the amount of a specimen passing through the immobilizing portion 4 is equivalent to a region between the end of the specimen X and the immobilizing portion 4, and a specimen between the immobilizing portion 4 and the capillary 8 has not passed through the immobilizing portion 4. FIG. 9 is a flowchart showing an optical property measuring process according to the present embodiment. After the amount of the specimen in the capillary 8 decreases to a criterion amount, the specimen is left for another predetermined standby time, so that a larger amount of the specimen passes through the immobilizing portion 4 than in the first embodiment. After that, the optical property of the immobilizing portion 4 is measured.

The standby time is an estimated time (flowing time) during which the specimen in the capillary 8 is supposed to reach, when the amount of the specimen in the capillary 8 decreases to the criterion amount, the immobilizing portion 4 indicated by an immobilizing portion specimen flow F in FIG. 8. Thus the optical property can be measured after the specimen between the immobilizing portion 4 and the capillary 8 passes through the immobilizing portion 4, the specimen having not passed through the immobilizing portion 4 when the end of the specimen X has reached the end E of the porous substrate 2. In the experiment of FIG. 6, the specimen reached the immobilizing portion 4 after 40 seconds. Thus in the second embodiment, when the amount of the specimen becomes equal to or less than the criterion, the measurement of the optical property is started after another standby time of 40 seconds.

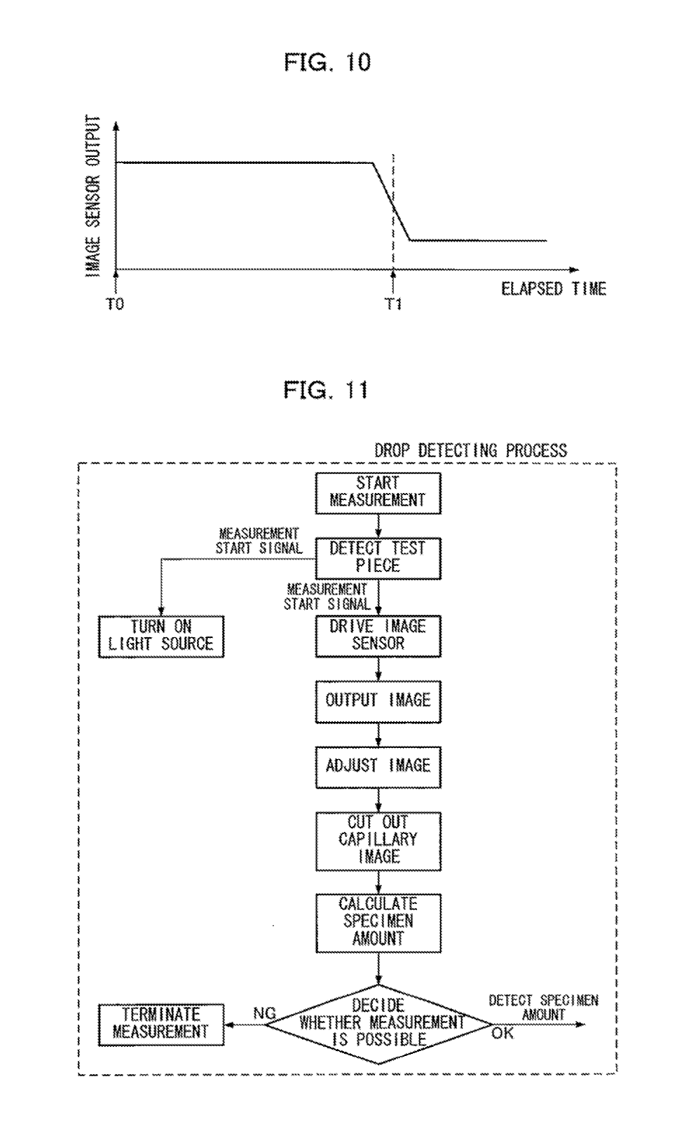

Referring to FIG. 10, another method of setting a standby time (flowing time) will be described below. FIG. 10 is a time-series plot of image sensor output values at a monitor point P (see FIG. 8) on the immobilizing portion 4. As to a monitor point output at specimen dropping time T0 when the specimen is dropped to the test piece 10, a high output can be obtained depending upon the reflection property of the porous substrate 2 because the specimen has not reached the monitor point P. The time after the dropping of the specimen is counted. When the specimen reaches the monitor point P, an image sensor output is reduced by the light absorption of the specimen. A monitor point arrival time T1 indicates a time at which the change of the output is detected. In this way, the standby time is set as a time T1 starting from the specimen dropping time T0 to the arrival of the specimen at the immobilizing portion 4, and the specimen is left for the standby time T1 from the time at which the amount of the specimen in the capillary 8 decreases to the criterion amount, thereby increasing the amount of the specimen passing through the immobilizing portion 4.

As previously mentioned, in the second embodiment, the specimen is left for the predetermined time after the amount of the specimen becomes equal to or less than the criterion. Thus the specimen passing through the immobilizing portion 4 can be increased by an equal amount, achieving an advantage of higher measurement sensitivity in addition to the accuracy of the first embodiment.

In the second embodiment, the monitor point P is set on the immobilizing portion 4. The monitor point P can be set at any point as long as a change of the image sensor output can be detected by the passage of the specimen on the test piece 10.

### Third Embodiment

A third embodiment will describe only different points from the first and second embodiments. In the first and second embodiments, the specimen is dropped after the test piece 10 is set. The present embodiment will describe a measurement method in which a test piece 10 is set in a solution measurement apparatus after a specimen is dropped to the test piece 10. FIG. 11 shows a drop (added solution) detecting process in the third embodiment. A specimen amount detecting process and an optical property measuring process are similar to those of the first embodiment shown in FIG. 2. Only the drop (added solution) detecting process is different from those of the other embodiments.

Referring to FIGS. 1 and 11, the following will describe the drop (added solution) detecting process of the solution measurement method according to the present embodiment (in other words, a controlling operation performed by a controller of the solution measurement apparatus). When the test piece 10 on which the specimen has been dropped is set in a stage 12, a detection switch 15 detects the setting of the test piece 10. Accordingly, a measurement start signal 34 is outputted to an error AMP 32 to turn on a light source 21 and an image sensor controller 26 is driven to image the test piece 10. By using the image of the test piece 10, a capillary image is cut out according to the same technique as in the foregoing embodiment and the amount of the specimen in a capillary 8 is calculated. In other words, when the test piece 10 is set in the stage 12, it is decided whether measurement is possible or not. In the measurement decision, it is decided whether or not the specimen dropped to the test piece 10 exceeds the reference value determined in the foregoing embodiment. In other words, in the capillary 8 having dimensions of 6.5 mm×1.7 mm (an area of 11.1 mm²) and a capacity of 5 μl, when the amount of the specimen is 4 mm² or less or has a ratio of 0.36 or less relative to the capillary area of 11.1 mm², it is decided that an excessive amount of the specimen has flown at the setting of the test piece 10 in the stage 12, and then the measurement is terminated. When the amount of the specimen is equal to or larger than this value, it is decided that the amount of the specimen is normal, and the process advances to the specimen amount detecting process to perform the subsequent processing. The subsequent processing is similar to that of the foregoing embodiment.

As previously mentioned, in the third embodiment, the test piece 10 on which the specimen has been dropped is set in the stage 12. Also in this case, the amount of the specimen in the capillary 8 is determined. When the amount of the specimen is equal to or smaller than a predetermined amount, it is decided that the specimen is in an abnormal state and the measuring operation is terminated. Thus it is possible to prevent measurement in an abnormal state where the amount of the specimen is insufficient and prevent erroneous measurement of a substance to be measured (erroneously small), thereby improving reliability.

In the embodiment, measurement is terminated when the amount of the specimen is small. Instead of or in parallel with this operation, a warning operation may be performed. Further, in the embodiment, the amount of the specimen in the capillary 8 is determined when the test piece 10 on which the specimen has been dropped is set in the stage 12. The present invention is not limited to this operation. The test piece 10 may be set in the stage 12 before the specimen is dropped, and then a change of the amount of the specimen in the capillary 8 may be detected when the specimen is dropped. The same controlling operation may be performed when the amount of the specimen is small.

In the present embodiment, a criterion enabling measurement is that the amount of the specimen is at least 4 mm² or has a ratio of at least 0.36 relative to the capillary area. Any other values may be used as long as the specimen can reach the end of a porous substrate 2.

### Fourth Embodiment

In the present embodiment, only different points from the first to third embodiments will be described. In the foregoing embodiments, only the amount of the specimen in each image of the test piece 10 is used in the decision on the amount of the specimen. In the present embodiment, considering that a specimen may be insufficiently applied to a capillary 8, a difference is determined between the initial amount of the specimen immediately after dropping and an amount of the specimen measured in each elapsed time, and the start of optical property measurement is decided using the determined value.

Referring to FIG. 12, the following will describe a specimen amount detecting process (in other words, a controlling operation performed by a controller of a solution measurement apparatus) of a solution measurement method according to a fourth embodiment. A drop (added solution) detecting process and an optical property measuring process are similar to those of the first embodiment shown in FIG. 2.

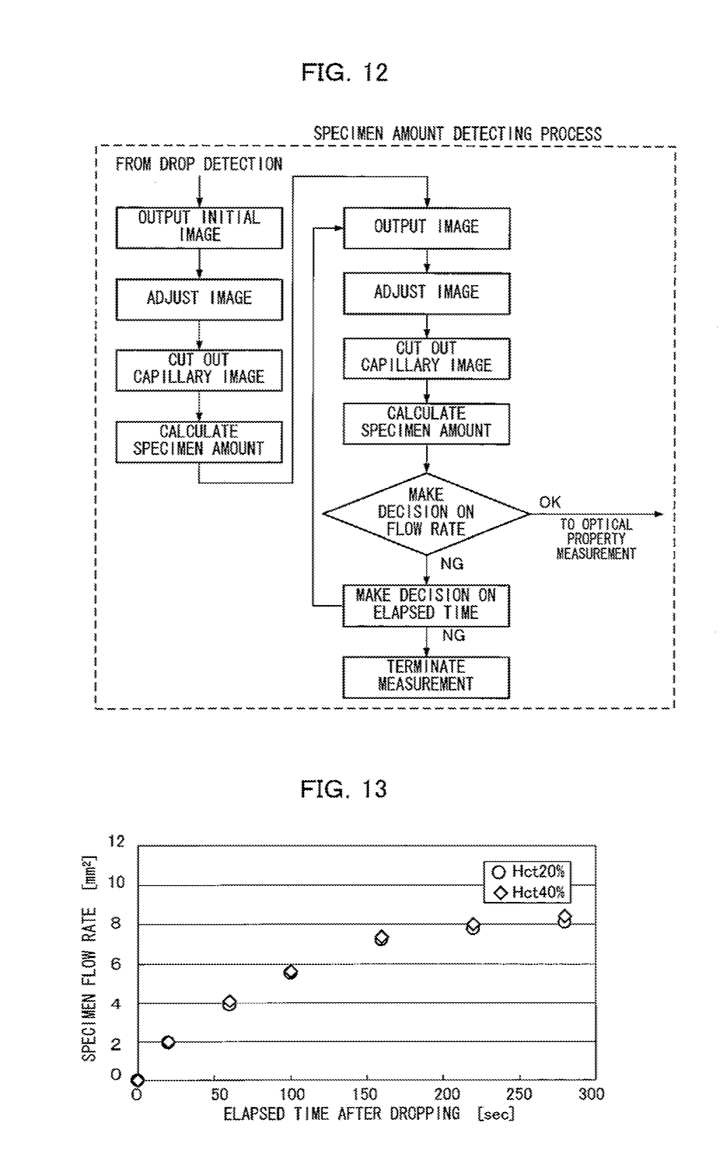

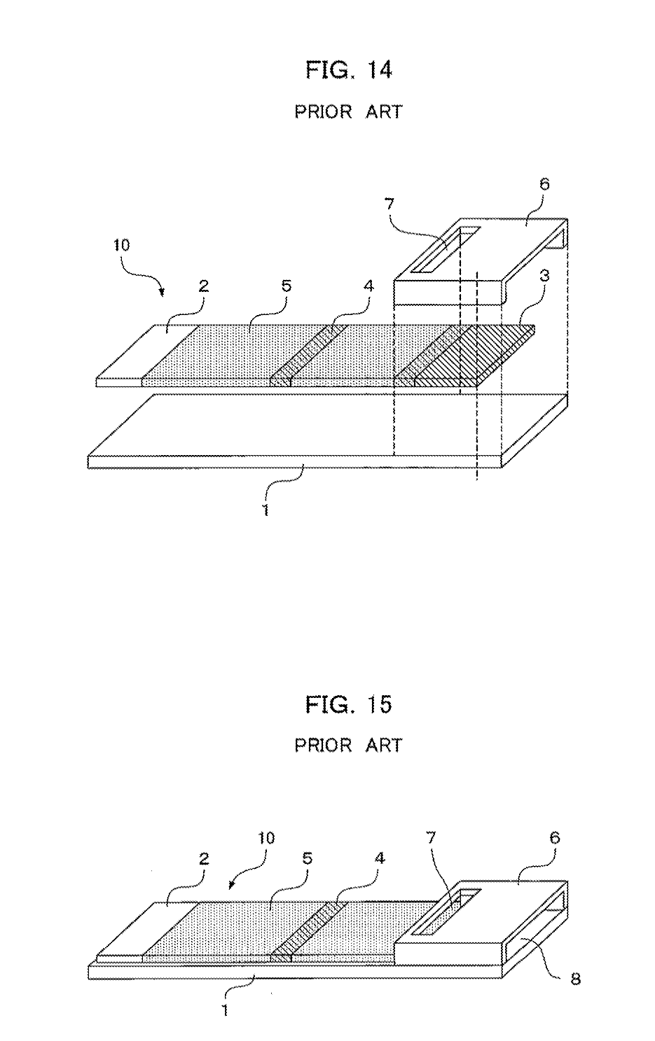

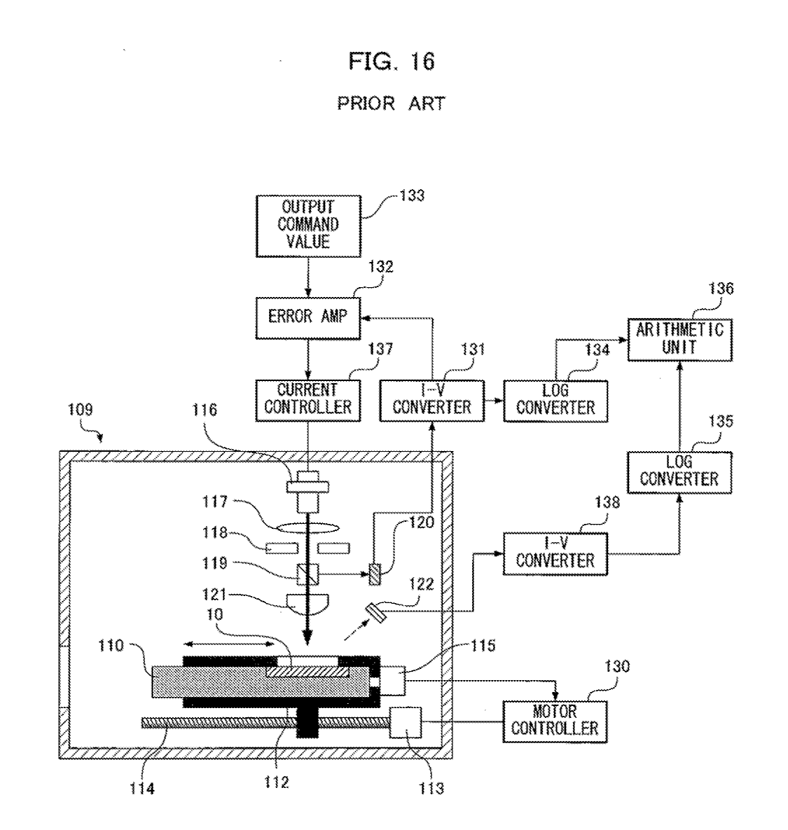

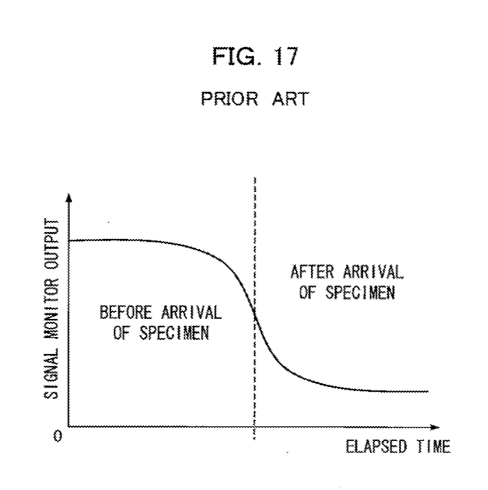

In the specimen amount detecting process of the solution measurement method according to the fourth embodiment, when the dropping of the specimen on a test piece 10 is detected in the drop detecting process, the test piece 10 is imaged to obtain an initial image and the amount of the specimen in the capillary 8 is determined as in the foregoing embodiments. The amount of the specimen is used as an initial value (specimen amount A). Further, the test piece 10 is imaged and the amount of the specimen (specimen amount B) in the capillary 8 is determined in each predetermined time period. A difference between the amounts (the specimen amount A—the specimen amount B) is obtained as the flow rate of the specimen from the capillary 8. FIG. 13 is a plot of the flow rates of blood specimens in each elapsed time, the blood specimens being sufficiently dropped to the test piece 10 with hematocrits (Hct) of 20% and 40%. As in the foregoing embodiments, the used capillary 8 had dimensions of 6.5 mm×1.7 mm (an area of 11.1 mm²) and a capacity of 5 μl. In this experiment, the specimen flowed to the end of a porous substrate 2 at 160 seconds to 220 seconds after the dropping. Thus when the flow rate of the specimen from the capillary 8 is at least 7 mm², it is decided that the flow of the specimen has ended. The amount of the specimen and the flow rate of the specimen are calculated in each predetermined time period until the flow rate reaches the criterion. When the flow rate exceeds the criterion within a time limit of 300 seconds, the process advances to the optical property measuring process. When the flow rate does not exceed the criterion, it is decided that the flow is abnormal and the measuring operation is terminated.

As previously mentioned, in the fourth embodiment, the test piece 10 is imaged immediately after the specimen is dropped, the amount of the specimen in the capillary 8 is calculated, and a difference from an amount of the specimen after the lapse of the predetermined time is determined as a flow rate of the specimen. The optical property of an immobilizing portion 4 is measured by using, as a criterion, the flow rate of the specimen when the specimen reaches the end of the porous substrate 2. Thus even when the capillary 8 is not sufficiently filled with the specimen dropped to the test piece 10 (also when the amount of specimen is equal to or larger than the predetermined minimum amount), a measuring operation can be performed with the same flow rate as on the capillary 8 filled with the specimen, so that the amount of the specimen passing through the porous substrate 2 can be always uniform and the measurement accuracy can be improved.

In the present embodiment, the criterion of a flow rate for starting measurement is set at 7 mm² or more. Other values can be used as long as a flow rate is obtained when the specimen reaches the end of the porous substrate 2.

In the present embodiment, the hematocrits of the specimens are 20% and 40%. The same criterion of the amount of specimen is applicable to other specimens having any hematocrits.

As previously mentioned, according to the solution measurement method and the solution measurement apparatus of the present invention, the amount of the specimen developing on the porous substrate 2, which serves as a development layer, is determined by measuring the amount of the specimen in the portion of the capillary 8 on the test piece 10, and the measurement of the optical property of the test piece is started when the flow rate of the specimen from the capillary 8 reaches the predetermined criterion. Thus it is possible to achieve an advantage of a uniform amount of specimen developing on the development layer and an improvement in the measurement accuracy of the solution measurement method and the solution measurement apparatus.

### INDUSTRIAL APPLICABILITY

A solution measurement method and a solution measurement apparatus according to the present invention are useful in various fields for measuring the optical property of a test piece that has a portion to be measured on a development layer and a solution storage portion such as a capillary to which a liquid is dropped. The portion to be measured includes an immobilizing portion of a substance to be measured.

1. A solution measurement method in which a solution to be tested is temporarily stored in a solution storage portion of a test piece when added to the test piece, the solution to be tested is developed on a development layer of the test piece from the solution storage portion, the development layer having a portion to be measured, and an amount of a substance to be measured in the solution to be tested is calculated by measuring an optical property of the portion to be measured,
the method comprising:
measuring the portion to be measured, in response to a reduction of the solution to be tested to a predetermined amount or less in the solution storage portion; and
calculating the amount of the substance to be measured in the solution to be tested, based on a measured value.

2. The solution measurement method according to claim 1, further comprising:
measuring a flowing time from addition of the solution to be tested to the test piece to the reduction of the solution to be tested in the solution storage portion to the predetermined amount or less;
waiting a time period corresponding to the flowing time after the solution to be tested in the solution storage portion reduces to the predetermined amount or less; and
calculating the amount of the substance to be measured in the solution to be tested, after the time period and based on the measured value of the portion to be measured.

3. A solution measurement method in which a solution to be tested is temporarily stored in a solution storage portion of a test piece when added to the test piece, the solution to be tested is developed on a development layer of the test piece from the solution storage portion, the development layer having a portion to be measured, and an amount of a substance to be measured in the solution to be tested is calculated by measuring an optical property of the portion to be measured,
the method comprising:
measuring an initial storage amount of the solution to be tested in the solution storage portion of the test piece, when the solution to be tested is added to the test piece mounted at a predetermined mounting location or when the test piece on which the solution to be tested has been added is mounted at the predetermined mounting location;
measuring a storage amount of the solution storage portion also after the solution to be tested is added;
measuring the optical property of the portion to be measured, in response to a reduction of the solution to be tested from the initial storage amount by a predetermined amount in the solution storage portion; and
calculating, based on a measured value, the amount of the substance to be measured in the solution to be tested.

4. The solution measurement method according to claim 3, further comprising:
measuring a flowing time from addition of the solution to be tested to the test piece to the reduction of the solution to be tested in the solution storage portion by the predetermined amount;
waiting a time period corresponding to the flowing time after the reduction of the solution to be tested in the solution storage portion by the predetermined amount; and
calculating the amount of the substance to be measured in the solution to be tested, after the time period and based on the measured value of the portion to be measured.

5. The solution measurement method according to claim 1, further comprising:
measuring an initial storage amount of the solution to be tested in the solution storage portion of the test piece, when the solution to be tested is added to the test piece mounted at a predetermined mounting location or when the test piece on which the solution to be tested has been added is mounted at the predetermined mounting location; and
performing at least one of a measurement terminating operation and a warning operation when the initial storage amount of the solution to be tested is smaller than predetermined initial storage setting.

6. The solution measurement method according to claim 1, wherein the test piece is a test piece for chromatography.

7. A solution measurement apparatus in which a solution to be tested is temporarily stored in a solution storage portion of a test piece when added to the test piece, the solution to be tested is developed on a development layer of the test piece from the solution storage portion, and an amount of a substance to be measured in the solution to be tested is calculated by measuring an optical property of a predetermined portion to be measured on the development layer of the test piece,
the solution measurement apparatus comprising:
an imaging device for imaging the portion to be measured and the solution storage portion of the test piece;
a solution amount detector for detecting, based on imaging information, an amount of the solution to be tested in the solution storage portion; and
a controller for measuring the portion to be measured, in response to a reduction of the solution to be tested to a predetermined amount or less in the solution storage portion or a reduction of the solution to be tested by the predetermined amount or more in the solution storage portion, and calculating, based on a measured value, the amount of the substance to be measured in the solution to be tested.

8. The solution measurement apparatus according to claim 7, further comprising an illuminator for illuminating the test piece with measurement light; and a light receiver for receiving reflected light of the measurement light having illuminated the test piece.

9. The solution measurement apparatus according to claim 8, wherein the illuminator is one of an LED, an LD, and a lamp.

10. The solution measurement apparatus according to claim 8, wherein the light receiver is an image sensor.

11. The solution measurement apparatus according to claim 7, wherein the test piece is a test piece for chromatography.

12. The solution measurement method according to claim 3, further comprising:
measuring an initial storage amount of the solution to be tested in the solution storage portion of the test piece, when the solution to be tested is added to the test piece mounted at a predetermined mounting location or when the test piece on which the solution to be tested has been added is mounted at the predetermined mounting location; and
performing at least one of a measurement terminating operation and a warning operation when the initial storage amount of the solution to be tested is smaller than predetermined initial storage setting.

13. The solution measurement method according to claim 3, wherein the test piece is a test piece for chromatography.
